(19) United States
(12) Patent Application Publication
(10) Pub. No.: US 2026/0359143 A1
(43) Pub. Date: Nov. 12, 2026

(54) System and Method for Adjusting Access to Computer Resources

(71) Applicant: The Toronto-Dominion Bank, Toronto (CA)

(72) Inventors: Zhaonan QIN, Toronto (CA); ZeZhong ZHENG, Toronto (CA); Kien Nghe LY, Toronto (CA)

(73) Assignee: The Toronto-Dominion Bank, Toronto (CA)

(21) Appl. No.: 19/202,215

(22) Filed: May 8, 2025

(51) Int. Cl. G06F 9/50

(52) U.S. Cl. CPC G06F 9/5083

(57) ABSTRACT

System, method and device for adjusting access to computer resources. The method includes, monitoring usage of computing resources for a plurality of applications in an enterprise system, monitoring interactions between client devices and the enterprise system, determining future event data correlated to higher or lower computing resource usage by the plurality of applications, using a machine learning model to predict a future computing resource usage requirement at a corresponding time period for each of the plurality of applications based on the monitored computing resource usage, the monitored interactions, and the future event data, automatically scheduling, at the corresponding time period, an adjustment to accessibility of the at least one of the computing resources to increase or decrease availability of the at least one of the computing resources for the time period, and implementing the adjustment at or for the time period to align computing resource availability with fluctuations in traffic.

### TECHNICAL FIELD

The following relates generally to adjusting access to computer resources and, more particularly, to increasing or decreasing availability of such computer resources using predictive machine learning models.

### BACKGROUND

Enterprise systems may provide platforms that provide an ability for client devices to interact with the enterprise system. These platforms may use various computer applications and services hosted on a multi-tenant computing environment. For example, the applications and services may relate to retrieving data and generating responses for real-time inferencing based on prompts and queries received during inquiries to the platform. Different types and amounts of computing resources may be required and need to be made available/accessible for the applications and services to be executed.

### BRIEF DESCRIPTION OF THE DRAWINGS

Embodiments will now be described with reference to the appended drawings wherein:

FIG. 1 is a schematic diagram of an example computing environment.

FIG. 2 illustrates a configuration of an enterprise system to provide an application platform with automatically managed computing resources.

FIG. 3 illustrates a configuration for consuming data in a knowledge hub for use by automated interactive entities.

FIG. 4 illustrates a configuration for the enterprise system to provide a contact centre utilizing the application platform.

FIG. 5 is a sequence diagram illustrating an example of a workflow for the enterprise system shown in FIG. 2.

FIG. 6 is a block diagram of an example configuration for a resource scheduler.

FIG. 7 is a block diagram of an example configuration for the enterprise system.

FIG. 8 is a block diagram of an example configuration of a client device.

FIG. 9 is a flow chart illustrating example operations that may be performed in adjusting access to computing resources.

FIG. 10 is a flow chart illustrating example operations that may be performed in utilizing an optimized schedule for resource access management.

FIG. 11 is a flow chart illustrating example operations that may be performed in providing and utilizing a dashboard for resource access management.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It is recognized that in some enterprise systems and platforms, access to particular computing resources needs be scheduled or reserved in advance of when such computing resources may be required. This often requires manual monitor of computing resource usage and manual scheduling of the upscaling and downscaling of computing resource access and availability for a future time period.

In multi-tenant computing environments, manually optimizing the scheduling and scaling of computing resource access and availability is a significant challenge, often resulting in discrepancies between the computing resources that are made available or accessible and those that are actually used. For example, a contact centre may struggle to balance the load between high-demand applications/services and those with sporadic usage and may over-purchase computing resources to manage peaks in the volume of customer inquiries, resulting in excessive operational costs.

The manual scheduling and scaling of computing resource access and availability in multi-tenant computing environments is inefficient and often results in discrepancies between the computing resources that are made accessible/available for use by various applications and services and the actual computing resource requirements of such applications and services. These discrepancies lead to higher operational costs when reserving or purchasing computing resources for future use. Manual upscaling and downscaling of computing resource access and availability are seen to be infeasible for optimizing computing resource usage in real-time, especially in environments with varying and unpredictable loads (e.g., customer contact centres).

Due to costing models around certain computing resources, an objective is to bring optimizations to real-time as much as possible such that load predictions can avoid wasted resource availability (when not used). Since there is an upper bound on efficiency when having too much of the computing resource, to much access is undesirable. At the other end of the spectrum, the lower bound of too little efficiency can cause applications and services to shut down and restart, which can lead to different types of costs associated with restarting, lost service, etc.

Machine learning (ML) models may be used to predict future computing resource usage requirements for computer applications and services used at an enterprise computing platform (e.g., customer contact centre). Predictions may be generated in real-time based on historical and real-time computing resource usage data, interaction data and data related to known or anticipated future events.

Based on the generated predictions, a computer-implemented automatic resource manager may continuously upscale and downscale computing resource access and availability for each application and service for a future time period. In this way, computing resource access and availability can be optimized based on the actual requirements of the contact centre's computer applications and services.

The follow describes a system and method for automatically optimizing and dynamically scaling computing resource access and availability for a computing platform, e.g., for resources in a multi-tenant computing environment, for processing client device interactions/inquiries at the platform. The system receives historical and real-time customer interaction data and computing resource usage data from the contact centre, which is used with an ML model to generate predictions about computing resource usage requirements for one or more future time periods.

According to one aspect, a computing system for adjusting access to computer resources is provided. The computing system includes a processor, and a memory coupled to the processor. The memory stores computer executable instructions that when executed by the processor cause the computing system to monitor usage of computing resources for a plurality of applications in an enterprise system, the computing resources being scalable for the plurality of applications based on varying requirements of the plurality of applications; monitor interactions between client devices and the enterprise system, the interactions being associated with usages of the plurality of applications; determine future event data correlated to higher or lower computing resource usage by the plurality of applications; use a machine learning model to predict a future computing resource usage requirement at a corresponding time period for each of the plurality of applications based on the monitored computing resource usage, the monitored interactions, and the future event data; automatically schedule, at the corresponding time period, an adjustment to accessibility of the at least one of the computing resources to increase or decrease availability of the at least one of the computing resources for the time period; and implement the adjustment at or for the time period to align computing resource availability with fluctuations in traffic associated with the plurality of applications.

In certain example embodiments, the system further includes instructions to repeat the predicting based on a schedule or in response to a detected trigger.

In certain example embodiments, the system further includes instructions to implement a further adjustment at a further time period to increase or decrease the availability of the at least one computing resource.

In certain example embodiments, the plurality of applications are associated with a multi-tenant computing environment.

In certain example embodiments, the at least one of the computing resources comprises access to a subscription-based artificial intelligence (AI) service.

In certain example embodiments, the AI service comprises using a generative AI model in a chat bot for interacting with the client devices.

In certain example embodiments, the machine learning model is periodically retrained based on feedback data obtained from the plurality of applications and interactions with at least one storage device.

In certain example embodiments, the monitored interactions include at least one of: volume of client access to a particular one of the plurality of applications, client traffic via a gateway to the enterprise system, contact centre requests, or data consumed during particular interactions.

In certain example embodiments, usage of the computing resources includes at least one of: utilization of high-efficiency and low-efficiency computer infrastructure, central processing unit (CPU) utilization, graphics processing unit (GPU) utilization, memory utilization, storage utilization, storage input/output operations per unit time period and network bandwidth utilization.

In certain example embodiments, usage data is quantified using tokens, requests, rates of tokens or rates of requests, or throughput units.

In certain example embodiments, the system further includes instructions to determine an optimized schedule for adjusting the accessibility to the computing resources for the plurality of applications at a plurality of future time periods based on the computed predictions; and implement the optimized schedule to automatically increase or decrease access to the computing resources.

In certain example embodiments, the system further includes instructions to provide a dashboard displaying monitored data and predicted future usage requirements.

In certain example embodiments, the dashboard enables changes to the made to resource scheduling to account for external constraints or policies.

In certain example embodiments, monitoring the interactions comprises accessing a knowledge hub used by services provided to client devices to determine how resource usage is affected by using different channels to interact with the enterprise system.

In another aspect, there is provided a method for adjusting access to computer resources. The method is implemented by a computing system and includes monitoring usage of computing resources for a plurality of applications in an enterprise system, the computing resources being scalable for the plurality of applications based on varying requirements of the plurality of applications; monitoring interactions between client devices and the enterprise system, the interactions being associated with usages of the plurality of applications; determining future event data correlated to higher or lower computing resource usage by the plurality of applications; using a machine learning model to predict a future computing resource usage requirement at a corresponding time period for each of the plurality of applications based on the monitored computing resource usage, the monitored interactions, and the future event data; automatically scheduling, at the corresponding time period, an adjustment to accessibility of the at least one of the computing resources to increase or decrease availability of the at least one of the computing resources for the time period; and implementing the adjustment at or for the time period to align computing resource availability with fluctuations in traffic associated with the plurality of applications.

In certain example embodiments, the method includes repeating the predicting based on a schedule or in response to a detected trigger.

In certain example embodiments, the method further includes implementing a further adjustment at a further time period to increase or decrease the availability of the at least one computing resource.

In certain example embodiments, the plurality of applications are associated with a multi-tenant computing environment.

In certain example embodiments, the at least one of the computing resources comprises access to a subscription-based AI service.

In another aspect, there is provided a computer readable medium storing computer-executable instructions for adjusting access to computer resources, including computer-executable instructions that, when executed by a computing system, cause the computing system to monitor usage of computing resources for a plurality of applications in an enterprise system, the computing resources being scalable for the plurality of applications based on varying requirements of the plurality of applications; monitor interactions between client devices and the enterprise system, the interactions being associated with usages of the plurality of applications; determine future event data correlated to higher or lower computing resource usage by the plurality of applications; use a machine learning model to predict a future computing resource usage requirement at a corresponding time period for each of the plurality of applications based on the monitored computing resource usage, the monitored interactions, and the future event data; automatically schedule, at the corresponding time period, an adjustment to accessibility of the at least one of the computing resources to increase or decrease availability of the at least one of the computing resources for the time period; and implement the adjustment at or for the time period to align computing resource availability with fluctuations in traffic associated with the plurality of applications.

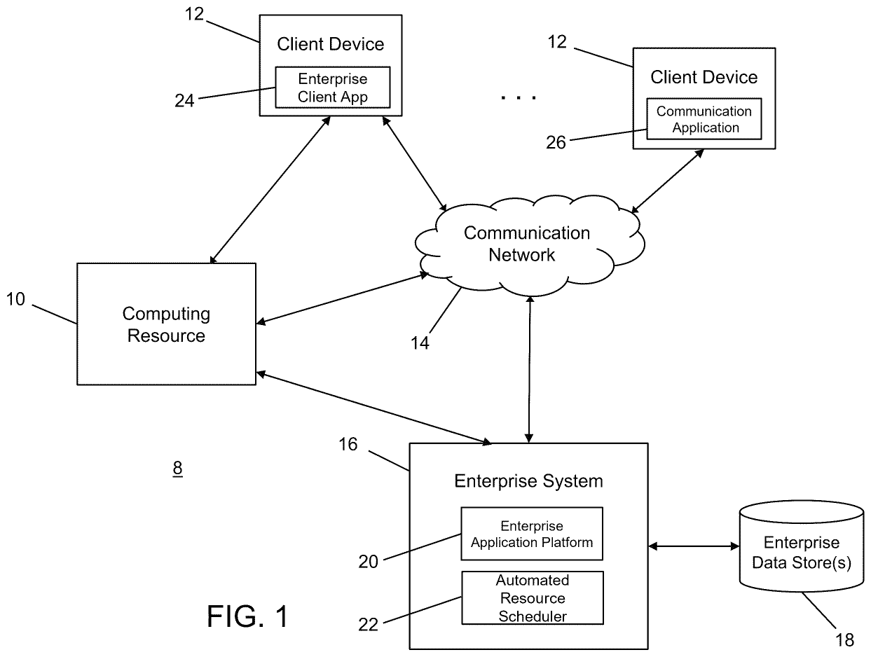

Referring now to the figures, FIG. 1 illustrates an example of a computing environment 8. In one aspect, the computing environment 8 may include one or more client devices 12, and one or more communications networks 14 connecting the components of the computing environment 8. The client devices 12 may include or otherwise have access to one or more computing resources 10 (e.g., ML models, generative artificial intelligence (AI) services using large language models (LLMs), cloud processing, cloud storage, graphics processing unit (GPU) usage, etc.), via the communication network 14.

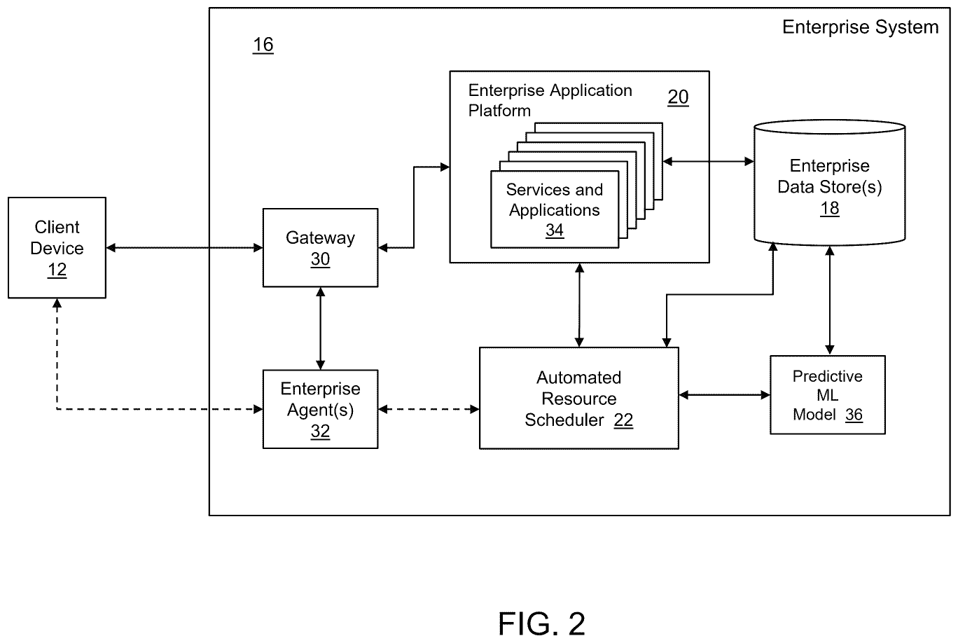

The computing environment 8 may also include an enterprise system 16 (e.g., a financial institution such as commercial bank and/or insurance provider) that provides financial services accounts to users and processes financial transactions associated with those financial service accounts. While several details of the enterprise system 16 have been omitted for clarity of illustration, reference will be made to FIGS. 2 and/or 7 below for additional details. The enterprise system 16 includes, at least in part, an enterprise application platform 20, which may be referred to as the application platform 20 herein for brevity. The application platform 20 may include, or, as shown in FIG. 1, have access to an automated resource scheduler 22. The automated resource scheduler 22 may be used to determine when and how much availability and access is required to the computing resources 10. While the computing resources 10 in FIG. 1 are shown separately from the enterprise system 16 it can be appreciated that some or all of such computing resources 10 utilized by the enterprise system 16 may be provided, accessed, made available and/or consumed from within the enterprise system 16. Moreover, while a single application platform 20 is shown in FIG. 1 it can be appreciated that the enterprise system 16 may include and host multiple different application platforms 20. For example, a financial institution may host a call center, a lending service, a banking service, and a trading service, each of which requiring and accessing its own computing resources.

The automated resource scheduler 22 enables the application platform 20 to determine when and how much of a particular computing resource 10 to make available to one or more applications running on the application platform 20. This may be accessing cloud-based assets such as servers, compute power, ML or other AI-based assets (e.g., LLMs, chatbots, etc.) or various types of multi-tenant computing resources 10. That is, the resource scheduler 22 can be configured to determine when to upscale or downscale access to such computing resources 10 to suit peak or off-peak demand, or to otherwise balance and control resource utilization. For example, such computing resources 10 may have associated fees and avoiding overcommitting to the computing resources 10 can minimize subscription fees, pay-as-you go fees, or other costs associated with accessing and utilizing the computing resources 10.

The computing resources 10 may be made available to the application platform 20 within the enterprise system 16 or via a 3^{rd} party, e.g., one or more 3^{rd} party services or sources provided access to the computing resources 10 as shown by way of example in FIG. 1. Such 3^{rd} party computing resources 10 typically have subscription or pay-as-you-go models for providing access to and usage of the offered computing resources 10. For example, an LLM or LLM-based chatbot may charge per token and provide access to a varying number of chatbot instances, nodes, or virtual environments. Cloud-based compute and storage models may also have a per-use or per time period charge associated with a unit of compute or storage. That is, the computing resources 10 may be offered to the enterprise system 16 according to various cost models which can be optimized by reducing over consumption, e.g., by avoiding overcommitting to the computing resources 10 when demand is not warranted.

The enterprise system 16 also includes or otherwise has access to one or more datastores 18 for storing enterprise system data, e.g., client data, subscription data, financial data, operational data, etc. For the sake of brevity, the client data may be referred to hereinafter as the enterprise data store 18 or data store 18. The enterprise system 16 may include other datastores not shown in FIG. 1. The data associated with a user can include client profile data that may be mapped to corresponding data for that user. For example, a financial institution may have an enterprise system 16 whose client data includes financial data. It can be appreciated that such financial data could also include transaction data and/or the enterprise data system data from the data store 18 shown in FIG. 1 and these datastores 18 are described separately for illustrative purposes. The enterprise data store 18 can include both data that is associated with a client as well as data that is associated with one or more user accounts for that client as recognized by the computing environment 8. The enterprise data store 18 may include operational data, including data used by the enterprise application platform 20 and which can be monitored by the automated resource scheduler 22.

The data associated with a client may include, without limitation, demographic data (e.g., age, gender, income, location, etc.), preference data input by the client, and inferred data generated through machine learning, modeling, pattern matching, or other automated techniques. The enterprise data store 18 may also include historical interactions and transactions associated with the enterprise system 16, e.g., login history, search history, communication logs, documents, etc.

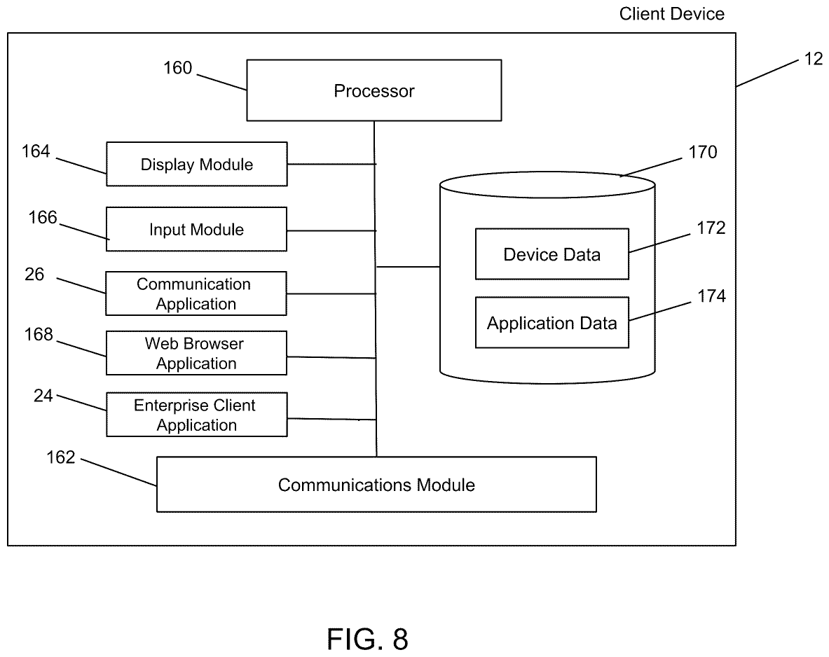

Client devices 12 may be associated with one or more users. Users may be referred to herein as customers, clients, policy holders, correspondents, or other entities that interact with the enterprise system 16 and/or computing resources 10 (directly or indirectly). The computing environment 8 may include multiple client devices 12, each client device 12 being associated with a separate user or associated with one or more users. In certain embodiments, a user may operate client device 12 such that client device 12 performs one or more processes consistent with the disclosed embodiments. In the example shown in FIG. 1, the client device 12 may include an enterprise client application (app) 24, which may also be referred to herein as a client app 24 for brevity. Client devices 12 may, alternatively or additionally, include a communication application 26, such as one that provides phone, text, email, chat, or other media, communication channels, etc. The communication application 26 may include one or more communication channels, including those that are other than one provided by the client app 24. For example, the user may use client device 12 to engage and interface with a mobile or web-based financial (banking) client app 24, which uses or incorporates subsystems of the enterprise system 16, discussed further below. The client devices 12 in this example show a client app 24 and/or communication application 26 but may also include a web browser application 168 (see FIG. 8) for accessing web-based applications.

The client devices 12 can access information within the enterprise system 16 and/or from the computing resources 10, or another remote computing environment associated with the enterprise system 16 in a variety of ways. For example, the client device 12 can access the enterprise system 16 via a web-based application, or a dedicated application such as the client app 24 or communication application 26, which communicate with the enterprise application platform 20. Access can require the provisioning of different types of credentials (e.g., login credentials, two factor authentication, etc.). In example embodiments, each different device 12 can be provided with a unique degree of access, or variations thereof. For example, the client device 12 can be provided with a greater degree of access to the enterprise system 16 compared to other devices.

In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of client devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network(s), and a private and/or public wide area network (e.g., the Internet).

The enterprise system 16 can be understood to encompass the whole of the enterprise, a subset of a wider enterprise system (not shown), such as a system serving a subsidiary, or a system for a particular branch or team of the enterprise (e.g., a resource migration division of the enterprise). In at least one example embodiment, the enterprise system 16 is a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc. Any of these applications may be made available to the client device 12 via a client app 24 and/or communication application 26.

The enterprise system 16 may include both on-premises and remote computing assets provided by a remote computing environment-not shown (hereinafter referred to in the alternative as computing resources 10). The remote computing environment includes resources used by, or available, to the enterprise system 16 that are stored or managed by a party other than operator of the enterprise system 16. For example, the computing resources 10 can include cloud-based storage services (e.g., database(s)). In at least some example embodiments, the computing resources 10 include one or more tools developed or hosted by the external party, or tools for interacting with the computing resources 10. In at least one contemplated embodiment, the tool (referred to in the singular for ease of reference) is a tool for managing data lakes, and more specifically a tool for scheduling writing to a data lake associated with the Microsoft™ Azure™ data storage and processing platform. Further particularizing the example, the tool can allow a client device 12 to access the computing resources 10, and to thereafter configure an ingestion procedure wherein different data files are assigned to different processors (e.g., hardware) within the computing resources 10. The tool can be or include aspects of an ML tool, or a tool associated with the Delta Lake Storage (ALDS)™ suite, etc. The computing resources 10 can also include hardware resources, such as access to processing capability of server devices (e.g., cloud computing), and so forth.

The computing resources 10 are shown as one or more separate entities in FIG. 1 for illustrative purposes and, in other configurations, may be part of or otherwise integrated into/with the enterprise system 16. As shown in FIG. 1, the computing resources 10 may be coupled to or in communication with the application platform 20, via the enterprise system 16, to permit a user of a client device 12 to obtain a response related to a request that is submitted via the enterprise client app 24 or other communication application 26 and directed through the application platform 20.

The enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the enterprise system 16. The cryptographic server may be used to protect the enterprise data store 18 by way of encryption for data protection, digital signatures or message digests for data integrity, and by using digital certificates to authenticate the identity of the users and client devices 12, with which the enterprise system 16 communicates to inhibit data breaches by adversaries. It can be appreciated that various cryptographic mechanisms and protocols can be chosen and implemented to suit the constraints and requirements of the particular deployment of the enterprise system 16 as is known in the art.

Turning now to FIG. 2, an example of a configuration for a process workflow utilized by/with the enterprise application platform 20 and automated resource scheduler 22, within a configuration of the enterprise system 16, is shown. In this example, client devices 12 may communicate with the enterprise system 16 to access the enterprise application platform 20 via a gateway 30. The gateway 30 may permit the client device 12 to communicate directly with the enterprise application platform 20, e.g., to utilize an application or service. For the sake of illustration, the enterprise application platform 20 may utilize any one or more of a number of different services and applications 34, configured in different ways for different purposes depending on the request or requirement of the client device 12.

The gateway 30 may additionally allow an enterprise agent 32 to communicate with the client device 12 directly and/or in connection with a session between the client device 12 and the enterprise application platform 20. The agent(s) 32 may be virtual or human, e.g., an administrator, employee, etc. As shown in FIG. 2 using a dashed line, the client device 12 may optionally have a capability of communicating with the enterprise agent 32 directly and outside of the gateway 30, e.g., via an additional communication channel such as one provided via the communication application 26. For example, the client device 12 may access the enterprise application platform 20 via the gateway 30 to perform some activity while at the same time communicate with an agent 32 via a phone, chat, or text channel.

The automated resource scheduler 22 includes or has access to a predictive ML model 36, which may be generated and trained locally or accessed and utilized from a third party or otherwise procured “off the shelf”. The model 36 enables the automated resource scheduler 22 to used monitored data to predict when and how to upscale or downscale access and availability of the services and applications 34 and any related computing resources 10 such as access to ML, AI or chatbot tools and services provided external to the enterprise system 16. The automated resource scheduler 22 is positioned and coupled to various elements within the enterprise system 16 for such monitoring, e.g., by observing interactions between the client device 12 and the gateway 30 and/or agents 32 as well as the particular services and applications 34 that are required to perform a task in response to a request by the client device 12. For example, as described in a below example, a client device 12 accessing a call centre related application platform 20 may require use of an AI-based chatbot via the gateway or via an automated agent 32, wherein the chatbot has a per-use or subscription based cost model such that costs increase during certain peak demand periods, e.g., when many client devices 12 are requiring access to such chatbots. Similarly, the services and applications 34 may require use of a third party LLM for generative-AI services in connection with a request made by the client device 12, e.g., to draft a document, generate and image, generate computer code, etc.

The automated resource scheduler 22 and the predictive ML model 36 may additionally monitor access to the enterprise data store 18 to determine storage requirements, number of access requests or any other metric that can be associated with the need for additional computing resources 10 at different time periods. The enterprise application platform 20 may provide various types and combinations of services and applications 34, include databases, UIs, AI services, or access to virtual machines, search services, GPU processors, etc. to name a few. The automated resource scheduler 22 may monitor which of the services and applications 34 are accessed at which time and how many instances may be required for different loads. This monitored data may be fed to the predictive ML model 36 to apply ML algorithms to perform resource utilization optimization based on time periods, triggers or other metrics. For example, the predictive ML model 36 may be used to infer that the release of a new feature on a client app 24 infers a spike in access to a virtual chatbot in the next forty eight hours and can upscale access to the services and applications 34 at the appropriate time.

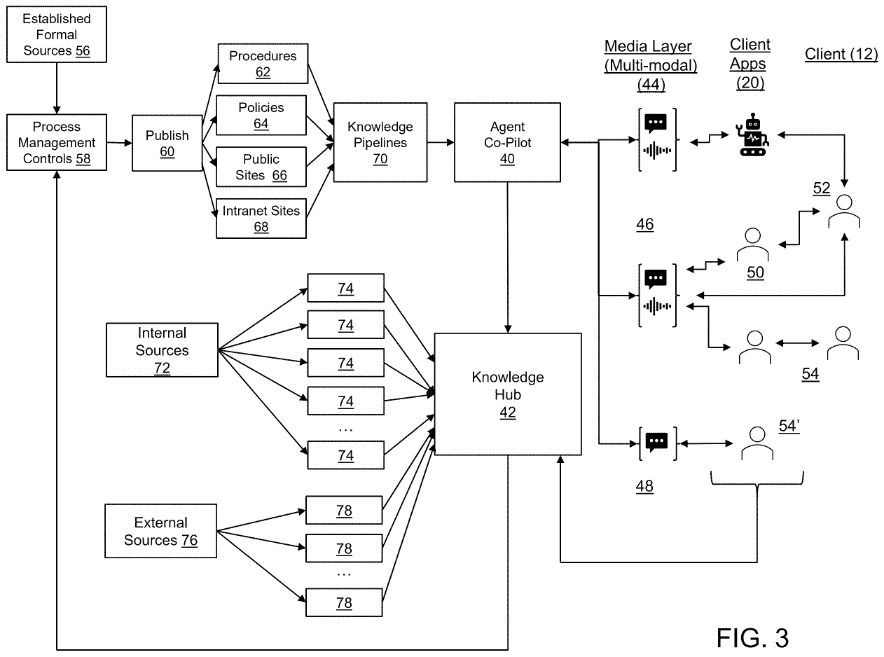

Referring now to FIG. 3, a knowledge control and retrieval workflow is shown, which illustrates the complexity of data usage monitoring that may be modeled by the predictive ML model 36 to determine data access needs related to AI-assisted processes such as access to a virtual chatbot. The automated resource scheduler 22 may be provided with access to a knowledge hub 42 as shown in FIG. 3, which provides an example of data types and sources that may be utilized and monitored in the enterprise system 16 by the automated resource scheduler 22 and provide inputs to the predictive ML model 36. The knowledge hub 42 may be utilized by an agent co-pilot 40, e.g., a chatbot used by the agent(s) 32 in assisting client devices 12 in their interactions with the enterprise system 16. The agent co-pilot 40 can be fed various knowledge pipelines 70 fed from, for example, procedures 62, policies 64, public sites 66, and intrant (internal) sites 68. These sets of data may be populated by a publish tool 60, which is controlled by process management controls 58. The process management controls 58 may be instructed by established formal sources 56.

The knowledge hub 42 may gather data from both internal sources 72 and external sources 76. Examples of internal document types 74 from the internal sources may include, without limitation, shared documents, internal documents, emails, instant messaging, personal notes, training documents, historical documents, etc. Examples of external document types 78 from external sources 76 may include, without limitation, product training, product references (e.g., manuals), internet sources, etc.

By gathering and coordinating document gathering and access controls as shown in FIG. 3, the knowledge hub 42 and agent co-pilot 40 can access enterprise data stores 18 and utilize enterprise system data from the data store(s) 18 in a coordinated and organized manner. The knowledge hub 42 may create a feedback loop with the process management controls to enable the sources 72, 76 to also feed the knowledge pipelines 70 over time. Any interaction or data flow shown in FIG. 3 may be monitored to assist in determining the resource requirements of certain processes, services, applications, platforms, etc. within the enterprise system 16.

As shown in FIG. 3, the agent co-pilot 40 may provide, in a media layer 44, automated text and/or voice communications via an AI agent 46. A text only AI agent 48 may also be provided, e.g., for internal employees 54′ (e.g., developers) in the enterprise system 16 and its environment. In person agents 50 may communicate with human users 52 via various client applications on the platform 20, e.g., by seeking help via a call centre either remotely or in person. These various interactions and interaction types create monitored events that the automated resource scheduler 22 may detect and feed to the predictive ML model 36 to determine when and how much to upscale or downscale access to computing resources 10 that enable these operations to occur. For example, each instance of the agent co-pilot 40 may have associated costs or burden on the enterprise system 16 for which additional computing resources 10 may be required for peak demand periods.

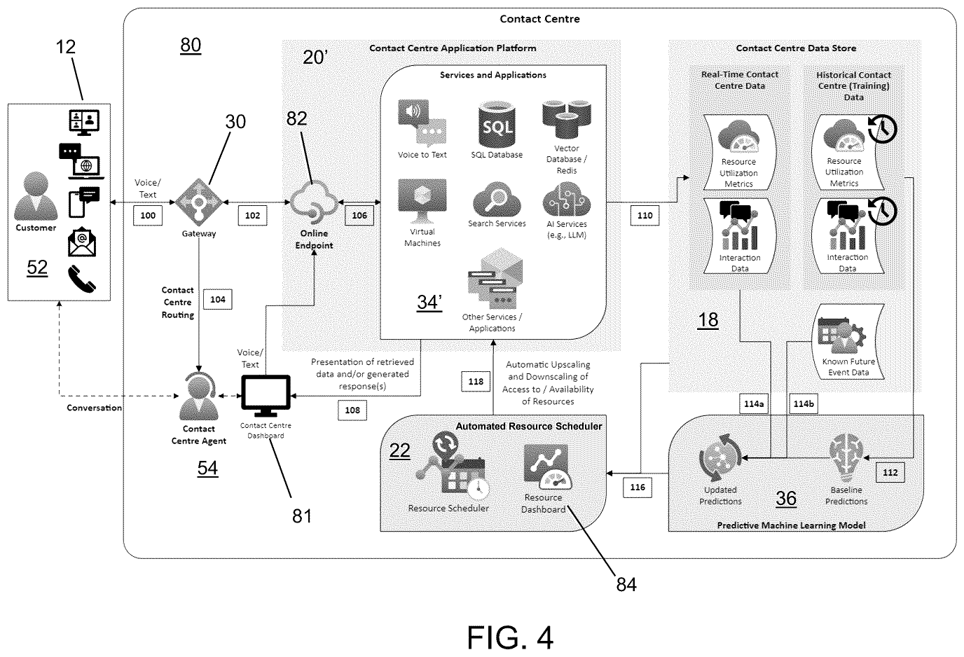

Referring now to FIG. 4, an example implementation of the configuration shown in FIG. 3 is shown for a contact centre 80. The contact centre 80 may be an embodiment of the enterprise system 16 or be a subsystem, unit or portion of the enterprise system 16. In this example, an external customer type of human user 52 is shown having access to various communication channels via a client device 12. The customer may communicate directly with the contact centre application platform 20′ via the gateway 30 and an online endpoint 82 or may alternatively or additionally communicate with a contact centre agent 54 who may utilize a contact centre dashboard 81 to present retrieved data and/or generated responses from access to the services and applications 34′. The automated resource scheduler 22 in this example may also include a resource dashboard 84, which may be accessed by administrators, including but not limited to the agents 54 or agents 32 (see FIG. 3). The predictive ML model 36 may have baseline predictions and updated predictions generated from monitored data, e.g. from the data stores 18 and/or platform 20′. In this example, the enterprise data stores 18 may store resource utilization metrics, interaction data, known future event data, etc., in addition to the data itself and any data access, modification or other interaction logs.

An example of a workflow using the configuration shown in FIG. 4 will now be described. At 100, a user contacts the contact centre 80 via phone call, email, SMS, online chat or other mode. The gateway 30 may be used to manage queues of incoming calls or messages and groups of contact centre live agents having various skills. The gateway 30 may also verify the user's identity (and customer/account information), allow the user 52 to perform self-service actions such as looking up their account balance, require the user 52 to select a reason for their inquiry and identify the appropriate contact centre agent skill group and other context about the inquiry (e.g., time, date and customer location).

At 102, the gateway 30 communicates with the contact centre application platform 20′ through the online endpoint 82, which is configured to host and deploy executable flows for calling various applications and services 34′ (e.g., virtual machines, structured (e.g., SQL) and unstructured data storage, caches, vector databases (e.g., Redis) and ML models (e.g., AI Search, OpenAI) for voice to text conversion, natural language processing, entity extraction, document and/or data retrieval and generating responses to prompts and queries). In one embodiment, the plurality of applications and services are hosted by a cloud computing platform such as Microsoft Azure®.

Thus, the gateway 30 may send and receive data about the user 52 and their inquiry to and from the contact centre application platform 20′ to identify/confirm the required skill group and how the inquiry should be prioritized or handled. The gateway 30 may hold the user 52 in an appropriate queue and route/transfer the user 52 to a specific contact centre agent 54 upon reaching the head of the queue, e.g., as shown at 104. It can be appreciated that, alternatively, if a user 52 contacts the contact centre 80 via phone call, an interactive voice response (IVR) system and automated call distributor (ACD) may collectively serve as a gateway 30.

At 106, the voice/text data from a conversation between a user 52 and contact centre agent 54, the data collected about the user 52 and their inquiry (e.g., by the gateway 30) and optional voice/text data inputted by the live contact centre agent 54 (collectively, “interaction data”) are routed through the online endpoint 82 and processed by various services and applications 34′ in real-time to extract prompts and queries. Existing data about the user 52 (e.g., “customer data”, such as account type(s) held, relevant product offerings, changes and/or actions taken in relation to the customer's account, etc.) and any previous interactions (“historical interaction data”) with the same customer stored in the data store(s) 18 may also be used to refine prompts and queries.

The online endpoint 82 may call various services and applications 34′ to perform appropriate functions based on the prompts and queries, as well as pre-determined functions, including document and/or data retrieval, sentiment analysis, response generation, interaction summarization and storage of processed data and outputs.

At 108, the outputs of the services and applications 34′ (e.g., retrieved documents and/or data, generated responses), including relevant customer data, are presented to the contact centre agent 54 through the contact centre dashboard 81 to assist the contact centre agent 54 in addressing the customer's requests and/or queries.

If the customer interacts only with an AI agent 46, 48, and not with a contact centre agent 54, the outputs may be provided directly to the user 52.

Various amounts of different computing resources 10 are typically required to execute the applications and services hosted by the contact centre application platform 20′. Computing resources 10 may include but are not limited to high-efficiency and low-efficiency (i.e., hot and cold) computer infrastructure, CPU usage, GPU usage, memory usage, storage usage and network bandwidth, some of which may be represented as tokens, tokens per minute (TPM), requests per minute (RPM) and throughput units (such as provisioned throughput units (“PTUs”) used by services managed by Microsoft Azure®).

At 110, after each customer interaction with the contact centre 90, data about the types and quantity of computing resources 10 used by each of the services and applications 34′ (“computing resource usage data”) and the interaction data are stored in a contact centre data store.

The computing resource usage requirements of each of the services and applications 34′ that were used at any given time depend on several factors, including the volume of interactions, the availability of contact centre agents, the complexity of customers'inquiries and the types of prompts or queries provided by customers, among others. The predictive ML model 36 is used to predict future computing resource usage requirements of the various services and applications 34′ of the contact centre application platform 20′ for a future time period (e.g., for each portion of a future day, week or month). The predictive ML model 36 may be trained on historical interaction data and historical computing resource usage data (collectively, “training data”).

Historical interaction data may include customer data and historical data related to the contact centre's volume of customer interactions, context and reasons for interactions, contact centre agent availability and the nature of the outputs of the services and applications 34′. Historical computing resource usage data include any historical data about the types and quantity of computing resources 10 used by each services and applications 34′ over a sampled period of time.

At 112, the predictive ML model 36 generates baseline predictions of future computing resource usage requirements for each application and service of the contact centre application platform 20′ for a future time period based on the historical business data and historical computing resource usage data. At 114a, after baseline predictions are generated, the predictive ML model 36 may continuously generate updated predictions of future computing resource usage requirements in real-time using updated interaction data and updated computing resource usage data collected after a pre-determined number of customer interactions, after pre-determined time intervals or when manually prompted.

At 114b, the predictive ML model 36 may also generate updated predictions of future computing resource usage requirements using “future event data” comprising data related to known future events (e.g., scheduled changes to products or services, scheduled changes to accounts, scheduled changes to the financial institution's operations or policies, etc.) that are anticipated to influence future interaction data and future computing resource usage data at a future time period.

At 116, the predictions generated by the predictive ML model 36 (collectively, “prediction data”) are used as inputs for the automated resource scheduler 22, which comprises at least an automatic scheduler for scheduling and executing the upscaling and downscaling of computing resource access and availability for each of the services and applications 34′ (see 118) and the dashboard 84 or other user interface for viewing interaction data, computing resource usage data, prediction data and the scheduled upscaling and downscaling of computing resource access and availability.

The automated resource scheduler 22 may continuously adjust the scheduling of upscaling and downscaling of computing resource access and availability as updated interaction data, updated computing resource usage data and updated future event data are received and used to generate updated prediction data, which is subsequently provided to the automatic resource manager by the predictive ML model 36.

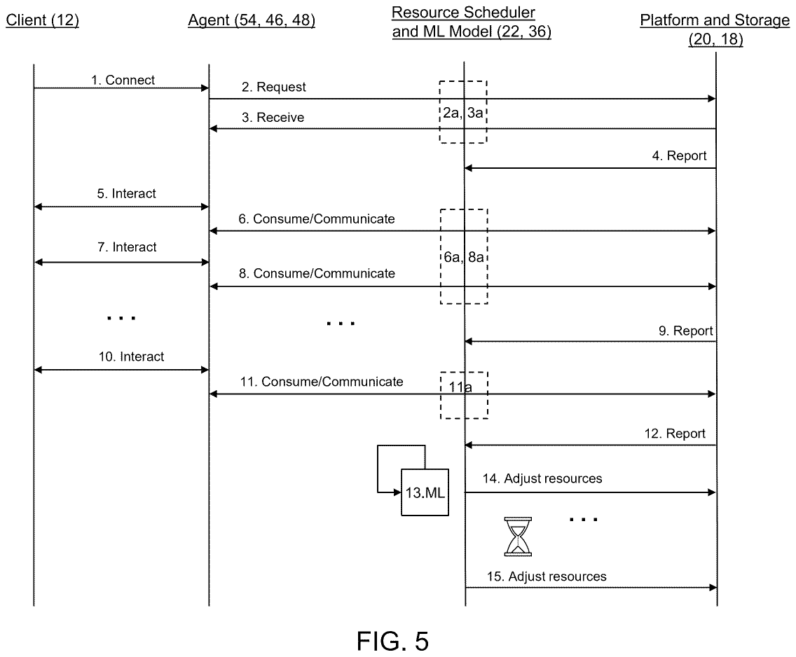

Referring now to FIG. 5, a sequence diagram is shown to illustrate capturing computing resource usage data and obtaining reports from the platform 20 and/or data store 18 to have the predictive ML model 36 schedule adjustments (e.g., upscaling, downscaling, adding, removing, ramping up/ramping down, etc.) to access and availability of the computing resources 10 used by the services and applications 34.

At step 1, the client device 12 connects to an agent 54, 46, 48 to generate a request at step 2. The request at step 2 may be redirected by the gateway 30 or online endpoint 82 to access certain available services and applications 34 or computing resources 10 via the platform 20 and/or data store 18. In response, a reply is received by the agent 54, 46, 48 at step 3. These interactions may be monitored at steps 2a and 2b by the resource scheduler 22 and/or predictive ML model 36 (shown in dashed box). Additionally, a report may be generated at step 4, e.g., a log file generated according to what computing resources 10 were utilized.

At step 5, the client 12 may interact with a contact centre agent 54 or AI agent 46, 48 (either or both virtual or human) and this may lead to consume and/or communicating with the services and applications 34 at step 6. This may repeat at steps 7 and 8 while interactions are captured by the automated resource scheduler 22 and/or predictive ML model 36 at steps 6a and 8b. By way of example, a periodic report may be issued at step 9, which can provide resource utilization data, cost data or provide future event data. This process of interacting and consuming/communicating may repeat, e.g., at steps 10 and 11 with an additional report generated at step 12, e.g., to indicate the end of a session. The interactions, data, and reports provide information which can be used at step 13 by the predictive ML model 36 to generate a schedule to optimize and adjust resources at step 14. As shown in FIG. 5, this may be done iteratively or at least at some other time to adjust the resource utilization at step 15.

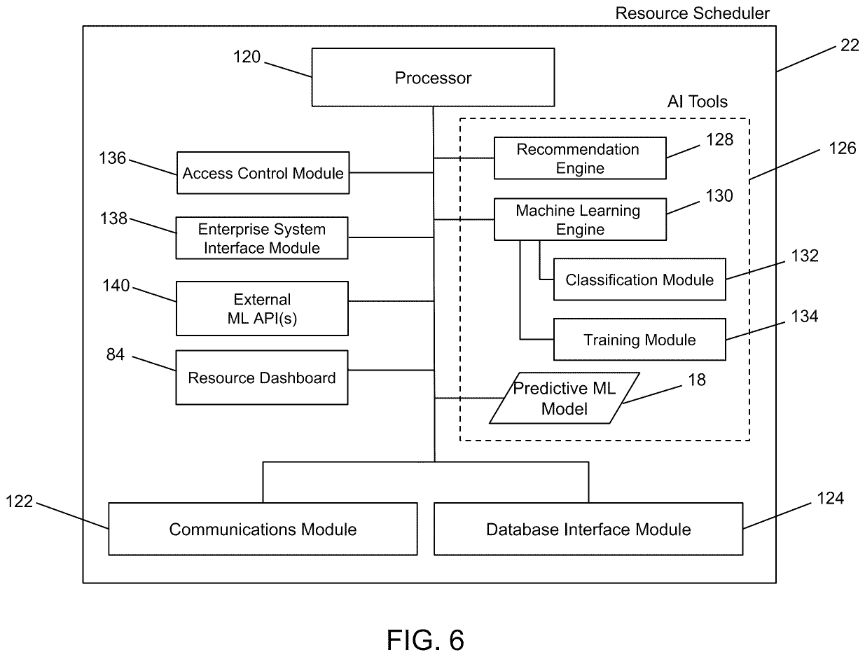

In FIG. 6, an example configuration of the automated resource scheduler 22 is shown. In certain example embodiments, the automated resource scheduler 22 may include one or more processors 120, a communications module 122, and a database interface module 124 for interfacing with the datastores and other data sources, to retrieve, modify, and store (e.g., add) data. Communications module 122 enables the automated resource scheduler 22 to communicate with one or more other components of the computing environment 8, such as client device 12, enterprise system 16, or computing resources 10, via a bus or other communication network, such as the communication network 14. While not delineated in FIG. 6, the automated resource scheduler 22 includes at least one memory or memory device that can include a tangible and non-transitory computer-readable medium having stored therein computer programs, sets of instructions, code, or data to be executed by processor 120.

FIG. 6 illustrates examples of modules, tools and engines stored in memory on the automated resource scheduler 22 and executed by the processor 120. It can be appreciated that any of the modules, tools, and engines shown in FIG. 6 may also be hosted externally and be available to the automated resource scheduler 22, e.g., via the communications module 122. In the example embodiment shown in FIG. 6, the automated resource scheduler 22 includes a suite or set of AI tools 126. The AI tools 126 include or otherwise have access to a recommendation engine 128, a machine learning engine 130, a classification module 132, a training module 134, and at least one trained model such as the predictive ML model 36. The automated resource scheduler 22 also includes an access control module 136, one or more external ML APIs 140 (e.g., to connect to an external LLM as one of the computing resources 10), and the resource dashboard 84. The automated resource scheduler 22 may also include an enterprise system interface module 138 to enable the automated resource scheduler 22 to interface with the enterprise application platform 20 and enterprise system 16 more generally.

The recommendation engine 128 is used by the AI tools 126 of the automated resource scheduler 22 to generate one or more recommendations for the automated resource scheduler 22 and/or a client device 12. It may be noted that a recommendation as used herein may refer to a prediction, suggestion, inference, association or other recommended identifier that can be used to generate a suggestion, notification, command, instruction or other data that can be viewed, used or consumed by the automated resource scheduler 22. The recommendation engine 128 can access data and information and apply one or more inference processes to generate the recommendation(s). The recommendation engine 128 may utilize or otherwise interface with the machine learning engine 130 to both classify data currently being analyzed to generate a suggestion or recommendation, and to train classifiers using data that is continually being processed and accumulated by the automated resource scheduler 22. That is, the recommendation engine 128 can learn outcomes, risk tiers and risk assessments, utilize confusion matrices, etc., and revise and refine classifications, rules or other analytics-related parameters over time. For example, the trained model (e.g., predictive ML model 36) can be updated and refined using the training module 134 as client devices 12 and/or the automated resource scheduler 22 interact with the client app 24 and/or enterprise application platform 20, during various interactions.

The machine learning engine 130 may also perform operations that classify the segmentation and other data (e.g., client data from the data store 18) in accordance with corresponding classifications parameters, e.g., based on an application of one or more machine learning algorithms to the data or groups of the data. The machine learning algorithms may include, but are not limited to, a one-dimensional, convolutional neural network model (e.g., implemented using a corresponding neural network library, such as Keras®), and the one or more machine learning algorithms may be trained against, and adaptively improved, using elements of previously classified profile content identifying suitable matches between content identified and potential actions to be executed. Subsequent to classifying the decision-related content or content being analyzed, the recommendation engine 128 may further process each element of the content to identify, and extract, a value characterizing the corresponding one of the classification parameters, e.g., based on an application of one or more additional machine learning algorithms to each of the elements of the decision-related content. By way of example, the additional machine learning algorithms may include, but are not limited to, an adaptive NLP algorithm that, among other things, predicts starting and ending indices of a candidate parameter value within each element of the content, extracts the candidate parameter value in accordance with the predicted indices, and computes a confidence score for the candidate parameter value that reflects a probability that the candidate parameter value accurately represents the corresponding classification parameter. As described herein, the one or more additional machine learning algorithms may be trained against, and adaptively improved using, the locally maintained elements of previously classified content. The ML API(s) 140 (or any suitable computing connection made between the automated resource scheduler 22 and the computing resources 10) may be used to additionally access and prompt an LLM for creating generative content. Classification parameters may be stored and maintained using the classification module 132, and training data may be stored and maintained using the training module 134.

The trained model (e.g., predictive ML model 36) may also be created, stored, refined, updated, re-trained, and referenced by the automated resource scheduler 22 (e.g., by way of the AI tools 126) to determine associations between actions and outcomes associated with behavior, and suitable responses or actions, and/or content related thereto. Such associations can be used to generate recommendations or suggestions for improving decisions being made, e.g., for determining when and how to act on such activity and behaviors to determine when and how much access and availability is required by the platform 20 at any given time.

In some instances, classification data stored in the classification module 132 may identify one or more parameters, e.g., “classification” parameters, that facilitate a classification of corresponding elements or groups of recognized content based on any of the exemplary machine learning algorithms or processes described herein. The one or more classification parameters may correspond to parameters that can indicate an affinity or compatibility between decision parameters and outcomes (e.g., approve or deny), and certain potential actions.

In some instances, the additional, or alternate, machine learning algorithms may include one or more adaptive, NLP algorithms capable of parsing each of the classified portions of the content and predicting a starting and ending index of the candidate parameter value within each of the classified portions. Examples of the adaptive, NLP algorithms include, but are not limited to, NLP models that leverage machine learning processes or artificial neural network processes, such as a named entity recognition model implemented using a SpaCy® library.

Examples of these adaptive, machine learning processes include, but are not limited to, one or more artificial, neural network models, such as a one-dimensional, convolutional neural network model, e.g., implemented using a corresponding neural network library, such as Keras®. In some instances, the one-dimensional, convolutional neural network model may implement one or more classifier functions or processes, such a Softmax® classifier, capable of predicting an association between an element of event data (e.g., a value or type of data being augmented with an event or workflow) and a single classification parameter and additionally, or alternatively, multiple classification parameters.

Based on the output of the one or more machine learning algorithms or processes, such as the one-dimensional, convolutional neural network model described herein, machine learning engine 130 may perform operations that classify each of the discrete elements of decision-related content as a corresponding one of the classification parameters, e.g., as obtained from classification data stored by the classification module 132.

The outputs of the machine learning algorithms or processes may then be used by the recommendation engine 128 to generate one or more suggested recommendations, instructions, commands, notifications, rules, or other instructional or observational elements that can be presented to the AI tools 126. The AI tools 126 may be used by any one or more of the operations shown in FIGS. 1-5 described herein. Similarly, the AI tools 126 may use the ML API(s) 140 to access third party computing resources 10 such as GPT-type services that use their own LLMs.

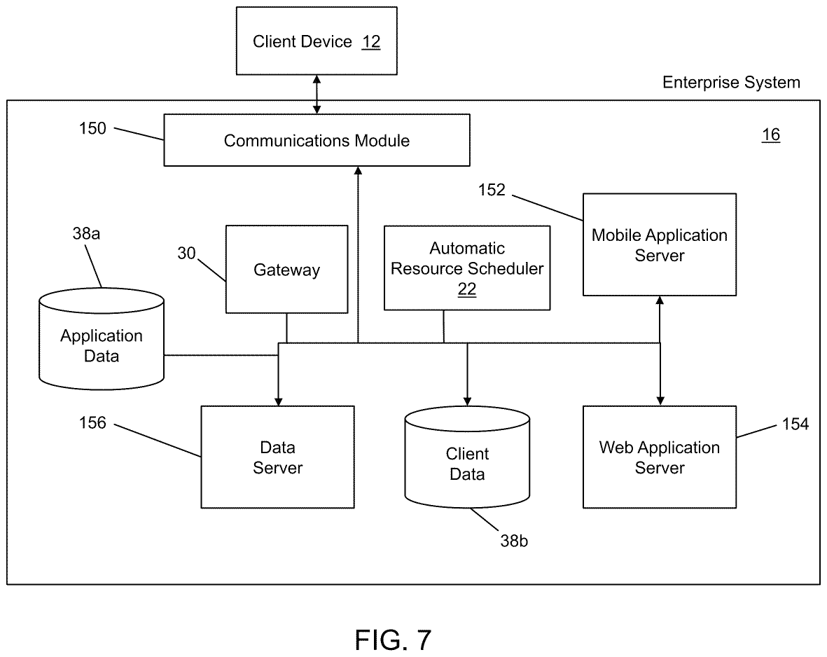

In FIG. 7, an example configuration of an enterprise system 16 is shown. The enterprise system 16 includes a communications module 150 that enables the enterprise system 16 to communicate with one or more other components of the computing environment 8, such as the computing resources 10 and/or client device(s) 12, via a bus or other communication network, such as the communication network 14. While not delineated in FIG. 7, the enterprise system 16 includes at least one memory or memory device that can include a tangible and non-transitory computer-readable medium having stored therein computer programs, sets of instructions, code, or data to be executed by one or more processors (not shown for clarity of illustration). FIG. 7 illustrates examples of servers and datastores/databases operable within the enterprise system 16. It can be appreciated that any of the components shown in FIG. 7 may also be hosted externally and be available to the enterprise system 16, e.g., via the communications module 150.

In the example embodiment shown in FIG. 7, the enterprise system 16 includes one or more servers to provide access to client data from the data store(s) 18, e.g., for making decisions related to a particular client or entity (e.g., user of client device 12). Exemplary servers include a mobile application server 152, a web application server 154 and a data server 156. The enterprise system 16 also includes the gateway 30 and the automated resource scheduler 22 in this example.

Although not shown in FIG. 7, as noted above, the enterprise system 16 may also include a cryptographic server for performing cryptographic operations and providing cryptographic services. The cryptographic server can also be configured to communicate and operate with a cryptographic infrastructure. The enterprise system 16 may also include one or more data storage elements for storing and providing data for use in such services, such as data storage for storing client data from the data store(s) 18.

Mobile application server 152 supports interactions with a mobile application installed on client device 12. Mobile application server 152 can access other resources of the enterprise system 16 to carry out requests made by, and to provide content and data to, a mobile application on client device. In certain example embodiments, mobile application server 152 supports a mobile banking application to provide payments from one or more accounts of user, among other things.

Web application server 154 supports interactions using a website accessed by a web browser application running on the client device. It can be appreciated that the mobile application server 152 and the web application server 154 can provide different front ends for the same application, that is, the mobile (app) and web (browser) versions of the same application. For example, the enterprise system 16 may provide a banking application that be accessed via a smartphone or tablet app while also being accessible via a browser on any browser-enabled device.

The client data in the data store(s) 18 can include, in an example embodiment, financial data that is associated with users of the client devices (e.g., customers of the financial institution). The financial data may include any data related to or derived from financial values or metrics associated with customers of a financial institution system (i.e. the enterprise system 16 in this example), for example, account balances, transaction histories, line of credit available, credit scores, mortgage balances, affordability metrics, investment account balances, investment values and types, among many others. Other metrics can be associated with the financial data, such as financial health data that is indicative of the financial health of the users of the client devices.

In FIG. 8, an example configuration of a client device 12 is shown. In certain embodiments, the client device 12 may include one or more processors 160, a communications module 162, and a data store 170 storing device data 172 and application data 174. Communications module 162 enables the client device 12 to communicate with one or more other components of the computing environment 8, such as the enterprise system 16 and/or computing resources 10, via a bus or other communication network, such as the communication network 14. While not delineated in FIG. 8, the client device 12 includes at least one memory or memory device that can include a tangible and non-transitory computer-readable medium having stored therein computer programs, sets of instructions, code, or data to be executed by processor 160. FIG. 8 illustrates examples of modules and applications stored in memory on the client device 12 and executed by the processor 160. It can be appreciated that any of the modules and applications shown in FIG. 8 may also be hosted externally and be available to the client device 12, e.g., via the communications module 162.

In the example embodiment shown in FIG. 8, the client device 12 includes a display module 164 for rendering GUIs and other visual outputs on a display device such as a display screen, and an input module 166 for processing user or other inputs received at the client device 12, e.g., via a touchscreen, input button, transceiver, microphone, keyboard, etc. The client device 12 may also include the communication application 26, which may take the form of a customized app, plug-in, widget, or software component provided by another application or be standalone. Similarly, the client device 12 may include the enterprise system client app 24 provided by the enterprise system 16. The client device 12 in this example embodiment also includes a web browser application 168 for accessing Internet-based content, e.g., via a mobile or traditional website. The data store 170 may be used to store device data 172, such as, but not limited to, an IP address or a MAC address that uniquely identifies client device 12 within environment 8. The data store 170 may also be used to store application data 174, such as, but not limited to, login credentials, user preferences, cryptographic data (e.g., cryptographic keys), etc.

It will be appreciated that only certain modules, applications, tools and engines are shown in FIGS. 1-4 and 6-8 for ease of illustration and various other components would be provided and utilized by the computing resources 10, client device 12, automated resource scheduler 22, and enterprise system 16 as is known in the art.

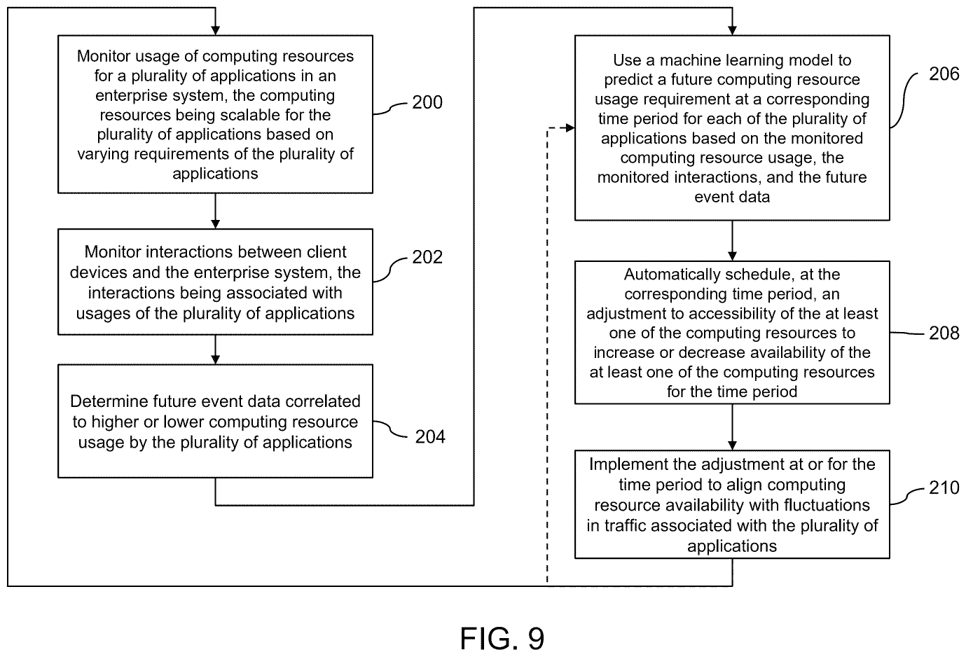

Referring now to FIG. 9, a flow chart illustrates operations that may be performed in adjusting access to computing resources. At block 200, the automated resource scheduler 22 monitors usage of computing resources 10 for applications in an enterprise system 16, e.g., the services and applications 34 utilized by the application platform 20. The computing resources 10, as discussed above, are scalable for those applications based on varying requirements of the applications. For example, the services and applications 34 may rely on an AI agent 46, 48 that has a per-session or per-token cost associated with usage thereof.

At block 202, the automated resource scheduler 22 monitors interactions between the client devices 12 and the enterprise system 16, e.g., via the gateway 30, access requests or writes to the data stores 18, access to the AI agents 46, 48, etc. The interactions, as discussed above, can be associated with usage of the services and applications 34 on the application platform 20. At block 204, the automated resource scheduler 22 determines future event data correlated to higher or lower computing resource usage by the applications (e.g., the services and applications 34 utilized by the application platform 20). The future event data may be generated by the data stores 18 or a utility associated therewith (e.g., as shown in FIG. 4) or may be determined from some other source, such as the application platform 20 or historical data stored by the enterprise system 16, e.g., data logs, access logs, etc.

At block 206, the automated resource scheduler 22 may use the predictive ML model 36 to predict a future computing resource requirement at a corresponding time period for each of the applications being monitored. This prediction is based on the monitored computing resource usage, the monitored interactions, and the future event data. At block 208, the automated resource scheduler 22 automatically schedules, at the corresponding time period, an adjustment (e.g., upscale or downscale applied to each computing resource 10 that is applicable) to accessibility of the computing resource(s) 10. This will increase or decrease that availability (e.g., scale up or down a number of instances, an amount of compute, an amount of storage, etc.) for that time period. That is, the adjustment may be temporary for a period of time as opposed to an increase or decrease that is set going forward. At block 210, the adjustment is implemented for the time period to align computing resource availability with fluctuations in traffic associated with the applications.

As shown in FIG. 9, the process may repeat as more monitoring takes place and/or can return to execution of a process that uses the predictive ML model 36 at block 206, e.g., when multiple different time periods require multiple different adjustments to the computing resource availability and usage.

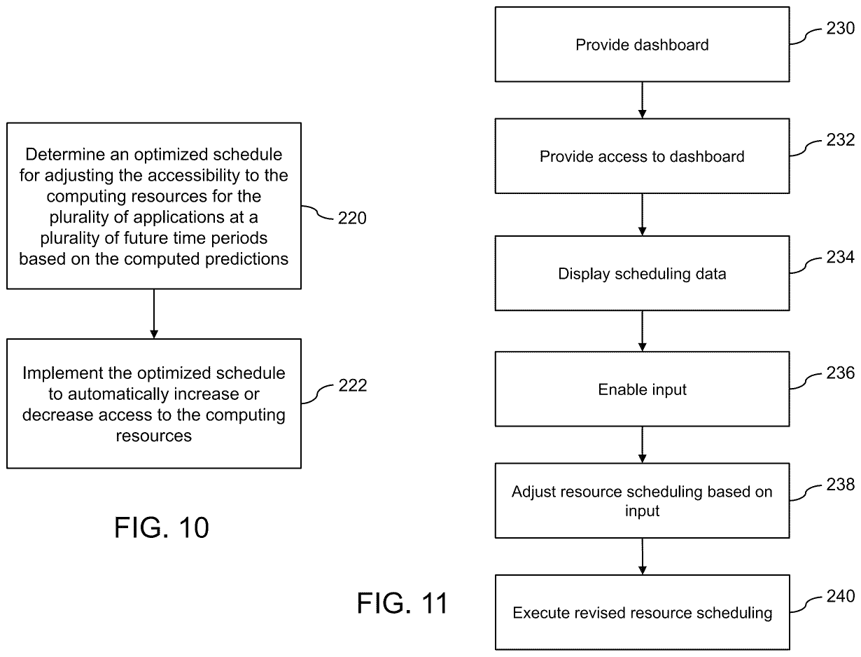

FIG. 10 is a flow chart illustrating example operations that may be performed in utilizing an optimized schedule for resource access management. At block 220, the automated resource scheduler 22 determines a optimized schedule for adjusting the accessibility to the computing resources 10 at a number of future time periods. For example, the predictions may include both peaks and valleys in usage thus requiring multiple different adjustments at different times during a day, week, month, year, etc.

At block 222, the automated resource scheduler 22 implements the optimized schedule to automatically increase or decrease access to the computing resources 10 accordingly.

FIG. 11 is a flow chart illustrating example operations that may be performed in providing and utilizing a dashboard for resource access management. At block 230, the automated resource scheduler 22 provides the dashboard 84 and, at block 232, provides access to the dashboard 84, e.g., to administrator entities such as an agent 54. At block 234, the dashboard 84 is used to display data such as scheduling associated with the adjustments described above and the associated time periods. At block 236, the automated resource scheduler 22 may permit inputs to be entered and, at block 238, permit adjustments to be made to the resource scheduling based on the input. At block 240, the automated resource scheduler 22 may execute the revised resource scheduling. Such changes to the resource scheduling may be made automatically, e.g., by a policy or security engine (not shown) to override scheduling decisions. For example, certain buffers may be required for certain services and applications 34 and a policy or security requirement may be imposed. This may be done by a computing entity or personnel.

It will be appreciated that any module or component exemplified herein that executes instructions may include or otherwise have access to memory embodied on a computer readable media (transitory and non-transitory) such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in the computing environment 8, or accessible or connectable thereto. Any application or module herein described may be implemented using computer readable/executable instructions that may be stored or otherwise held by such computer readable media.

It will also be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A computing system for adjusting access to computer resources, the computing system comprising:
a processor; and
a memory coupled to the processor, the memory storing computer executable instructions that when executed by the processor cause the computing system to:
monitor usage of computing resources for a plurality of applications in an enterprise system, the computing resources being scalable for the plurality of applications based on varying requirements of the plurality of applications;
monitor interactions between client devices and the enterprise system, the interactions being associated with usages of the plurality of applications;
determine future event data correlated to higher or lower computing resource usage by the plurality of applications;
use a machine learning model to predict a future computing resource usage requirement at a corresponding time period for each of the plurality of applications based on the monitored computing resource usage, the monitored interactions, and the future event data;
automatically schedule, at the corresponding time period, an adjustment to accessibility of the at least one of the computing resources to increase or decrease availability of the at least one of the computing resources for the time period; and
implement the adjustment at or for the time period to align computing resource availability with fluctuations in traffic associated with the plurality of applications.

2. The computing system of claim 1, wherein the system further comprises instructions to:
repeat the predicting based on a schedule or in response to a detected trigger.

3. The computing system of claim 2, wherein the system further comprises instructions to:
implement a further adjustment at a further time period to increase or decrease the availability of the at least one computing resource.

4. The computing system of claim 1, wherein the plurality of applications are associated with a multi-tenant computing environment.

5. The computing system of claim 1, wherein the at least one of the computing resources comprises access to a subscription-based artificial intelligence (AI) service.

6. The computing system of claim 5, wherein the AI service comprises using a generative AI model in a chat bot for interacting with the client devices.

7. The computing system of claim 1, wherein the machine learning model is periodically retrained based on feedback data obtained from the plurality of applications and interactions with at least one storage device.

8. The computing system of claim 1, wherein the monitored interactions comprise at least one of: volume of client access to a particular one of the plurality of applications, client traffic via a gateway to the enterprise system, contact centre requests, or data consumed during particular interactions.

9. The computing system of claim 1, wherein usage of the computing resources includes at least one of: utilization of high-efficiency and low-efficiency computer infrastructure, central processing unit (CPU) utilization, graphics processing unit (GPU) utilization, memory utilization, storage utilization, storage input/output operations per unit time period and network bandwidth utilization.

10. The computing system of claim 9, wherein usage data is quantified using tokens, requests, rates of tokens or rates of requests, or throughput units.

11. The computing system of claim 1, wherein the system further comprises instructions to:
determine an optimized schedule for adjusting accessibility to the computing resources for the plurality of applications at a plurality of future time periods based on the computed predictions; and
implement the optimized schedule to automatically increase or decrease access to the computing resources.

12. The computing system of claim 1, wherein the system further comprises instructions to:
provide a dashboard displaying monitored data and predicted future usage requirements.

13. The computing system of claim 12, wherein the dashboard enables changes to be made to resource scheduling to account for external constraints or policies.

14. The computing system of claim 1, wherein monitoring the interactions comprises accessing a knowledge hub used by services provided to client devices to determine how resource usage is affected by using different channels to interact with the enterprise system.

15. A method for adjusting access to computer resources, the method being implemented by a computing system and comprising:
monitoring usage of computing resources for a plurality of applications in an enterprise system, the computing resources being scalable for the plurality of applications based on varying requirements of the plurality of applications;
monitoring interactions between client devices and the enterprise system, the interactions being associated with usages of the plurality of applications;
determining future event data correlated to higher or lower computing resource usage by the plurality of applications;
using a machine learning model to predict a future computing resource usage requirement at a corresponding time period for each of the plurality of applications based on the monitored computing resource usage, the monitored interactions, and the future event data;
automatically scheduling, at the corresponding time period, an adjustment to accessibility of the at least one of the computing resources to increase or decrease availability of the at least one of the computing resources for the time period; and
implementing the adjustment at or for the time period to align computing resource availability with fluctuations in traffic associated with the plurality of applications.

16. The method of claim 15, further comprising repeating the predicting based on a schedule or in response to a detected trigger.

17. The method of claim 16, further comprising implementing a further adjustment at a further time period to increase or decrease the availability of the at least one computing resource.

18. The method of claim 15, wherein the plurality of applications are associated with a multi-tenant computing environment.

19. The method of claim 15, wherein the at least one of the computing resources comprises access to a subscription-based artificial intelligence (AI) service.

20. A non-transitory computer readable medium storing computer-executable instructions for adjusting access to computer resources, comprising computer-executable instructions that, when executed by a computing system, cause the computing system to:
monitor usage of computing resources for a plurality of applications in an enterprise system, the computing resources being scalable for the plurality of applications based on varying requirements of the plurality of applications;
monitor interactions between client devices and the enterprise system, the interactions being associated with usages of the plurality of applications;
determine future event data correlated to higher or lower computing resource usage by the plurality of applications;
use a machine learning model to predict a future computing resource usage requirement at a corresponding time period for each of the plurality of applications based on the monitored computing resource usage, the monitored interactions, and the future event data;
automatically schedule, at the corresponding time period, an adjustment to accessibility of the at least one of the computing resources to increase or decrease availability of the at least one of the computing resources for the time period; and
implement the adjustment at or for the time period to align computing resource availability with fluctuations in traffic associated with the plurality of applications.
